(19) United States
(12) Patent Application Publication
(10) Pub. No.: US 2022/0396507 A1
(43) Pub. Date: Dec. 15, 2022

(54) METHOD FOR DEGRADING ANTIBIOTICS BY AQUEOUS PHASE TRANSFER CATALYSIS USING AN ANIONIC LIQUID AND HYDROGEN PEROXIDE

(71) Applicant: Kunming University of Science and Technology, Kunming City (CN)

(72) Inventors: Yingjie LI, Kunming City (CN); Senlin TIAN, Kunming City (CN); Huaying LIU, Kunming City (CN); Maoze HOU, Kunming City (CN); Yina TU, Kunming City (CN); Qun ZHAO, Kunming City (CN)

(73) Assignee: Kunming University of Science and Technology, Kunming City (CN)

(21) Appl. No.: 17/663,238

(22) Filed: May 13, 2022

(30) Foreign Application Priority Data
Jun. 9, 2021 (CN) 202110644434.5

(51) Int. Cl. C02F 1/72; C07F 17/02; C07F 15/02

(52) U.S. Cl. CPC C02F 1/722; C02F 1/725; C07F 17/02; C07F 15/02; C02F 2103/343

(57) ABSTRACT

Disclosed is a method for degrading antibiotics by aqueous phase transfer catalysis using an anionic liquid and hydrogen peroxide, including: adding hydrogen peroxide to a wastewater containing the antibiotics to obtain a first mixture, and adjusting a pH of the first mixture to 3-4 to form an aqueous phase, and adding a catalyst to a water-insoluble ionic liquid to obtain a second mixture, and stirring the second mixture to form an ionic liquid phase, wherein the catalyst is selected from the group consisting of ferrocene, iron dodecyl sulfonate, ferrous dodecyl sulfonate, and copper dodecyl sulfonate; and mixing the aqueous phase and the ionic liquid phase in a volume ratio of (8-11):1 to obtain a mixed phase, and stirring the mixed phase to degrade the antibiotics.

### TECHNICAL FIELD

The present disclosure relates to the technical field of antibiotic wastewater treatment, in particular to a method for degrading antibiotics by aqueous phase transfer catalysis using an anionic liquid and hydrogen peroxide.

### BACKGROUND ART

Antibiotics are a type of environmental micro-pollutants frequently detected in wastewater and surface water, and are highly polar and non-volatile. If the antibiotics are directly discharged into water body, they can not be biodegraded by the water body, which would not only cause great changes in water quality, making aquatic organisms unable to survive, but also destroy water ecosystem, thereby affecting the normal production and life of people near water basin. These pollutants could be converted into more easily biodegraded small molecular acids, and mineralized into harmless substances such as CO₂ and H₂O by an advanced oxidation technology. Therefore, the advanced oxidation technology is widely used for the treatment of organic pollutants in wastewater.

Photo-assisted-homogeneous Fenton (Fe²⁺/Fe³⁺/H₂O₂) oxidation is a common method for eliminating organic pollutants in water, which has been widely used in the treatment of organic wastewater due to its advantages of simple operation, low cost, and environmental friendliness. The mechanism of the oxidation is to combine an oxidant and a catalyst by technologies such as photoelectricity, ultrasonic, and ozone so as to generate hydroxyl radicals (.OH) with strong oxidizing properties, thus degrading organic pollutants. However, the above method still has many shortcomings, such as narrow pH range (2.5-3.5), large consumption of iron salt and H₂O₂, and easy generation of iron hydroxide sludge which will lead to a secondary pollution.

Ferrocene (Fc) is an organic transition metal compound with poor water solubility, stable chemical properties, and environmentally friendly properties, and is widely used in fields such as agriculture, medicine, energy saving, and environmental protection. As disclosed by Zhang Biaojun et al. (Zhang Biaojun, Zhao Yaoyunchuan, Fang Qi, et al. Degradation of sulfamethazine by photo-assisted-ferrocene/H₂O₂ heterogeneous system [J]. Environmental Science, 2018, 39 (11):205-212.), sulfamethazine was degraded under light with ferrocene as a catalyst, but the degradation was carried out in a heterogeneous system which has problems of low catalytic efficiency and difficult recycling of Fc after the degradation. Therefore, it is necessary to develop a method for degrading antibiotics by aqueous phase transfer catalysis using an anionic liquid and hydrogen peroxide that could solve the above problems.

### SUMMARY

An object of the present disclosure is to provide a method for degrading antibiotics by aqueous phase transfer catalysis using an anionic liquid and hydrogen peroxide.

In order to achieve the above object, the present disclosure provides the following solutions:

Provided is a method for degrading antibiotics by aqueous phase transfer catalysis using an anionic liquid and hydrogen peroxide, comprising:

step 1, adding hydrogen peroxide to a wastewater containing the antibiotics to obtain a first mixture, and adjusting a pH of the first mixture to 3-4 to form an aqueous phase; and

adding a catalyst to a water-insoluble ionic liquid to obtain a second mixture, and stirring the second mixture to form an ionic liquid phase, wherein the catalyst is selected from the group consisting of ferrocene, iron dodecyl sulfonate, ferrous dodecyl sulfonate and copper dodecyl sulfonate; and

step 2, mixing the aqueous phase and the ionic liquid phase obtained in step 1 in a volume ratio of (8-11):1 to obtain a mixed phase, and stirring the mixed phase to degrade the antibiotics.

The present disclosure has the following beneficial effects:

1. In the present disclosure, the ionic liquid could not only be used as a solvent, but also have a catalytic effect. The ionic liquid and the catalyst co-catalyze hydrogen peroxide to generate hydroxyl radicals, which could effectively speed up the reaction, realize homogeneous catalysis of hydrogen peroxide to degrade antibiotics, and finally generate small harmless molecules. Moreover, the ionic liquid and catalyst could be reused, thus solving the problem of difficult catalyst recovery in heterogeneous catalysis, and conforming to the concept of modern circular economy, namely being environmentally friendly. The method of the present disclosure also could overcome the shortcomings of conventional solvents that the solvent is volatile and easy to corrode equipment.

2. The method of the present disclosure has the advantages of simple process, high efficiency, low requirements for reaction conditions, complete degradation, no secondary pollution, energy saving and environmental protection, and the method is suitable for the treatment of a wide range of antibiotics. The ionic liquid and catalyst could be reused for several time, allowing a significant reduction in cost. Therefore, the method of the present disclosure has broad application prospects.

3. In the method of the present disclosure, the catalyst may be selected from the group consisting of ferrocene, iron dodecyl sulfonate, ferrous dodecyl sulfonate and copper dodecyl sulfonate, which broadens the types of catalysts and is suitable for degrading antibiotics under various conditions. Therefore, the method of the present disclosure has wide application scenarios.

### DETAILED DESCRIPTION OF THE EMBODIMENTS

The present disclosure is further described below in conjunction with examples, and does not be limited in any way. Any variations or replacement made based on the teachings of the present disclosure should fall within the protection scope of the present disclosure.

The present disclosure provides a method for degrading antibiotics by aqueous phase transfer catalysis using an anionic liquid and hydrogen peroxide, comprising:

step 1, adding hydrogen peroxide to the wastewater containing the antibiotics to obtain a first mixture, and adjusting a pH of the first mixture to 3-4 to form an aqueous phase, wherein the pH of the first mixture may be adjusted by a pH regulator well known to those skilled in the art, such as sulfuric acid and sodium hydroxide; and

adding a catalyst to a water-insoluble ionic liquid to obtain a second mixture, and stirring the second mixture to form an ionic liquid phase, wherein the catalyst is selected from the group consisting of ferrocene, iron dodecyl sulfonate, ferrous dodecyl sulfonate and copper dodecyl sulfonate; and

step 2, mixing the aqueous phase and the ionic liquid phase obtained in step 1 in a volume ratio of (8-11):1 to obtain a mixed phase, and stirring the mixed phase to degrade the antibiotics.

In some embodiments, a concentration of the antibiotics in the aqueous phase is in a range of 0.05-0.2 mmol/L, a concentration of hydrogen peroxide in the aqueous phase is in a range of 10-30 mmol/L, and a concentration of the catalyst in the ionic liquid phase is in a range of 25-50 mmol/L.

In some embodiments, in step 1, stirring the second mixture is performed at ambient temperature for 30-60 min.

In some embodiments, in step 2, the stirring is performed for 0.5-5 hours.

In some embodiments, the ionic liquid is an ionic compound composed of an anion and a cation, and is insoluble in water and compatible with catalysts, wherein the cation is an alkyl imidazolium cation, such as EMIM⁺ and BMIM⁺, and the anion is BF₄⁻ or PF₆⁻. For example, the ionic liquid may be 1-octyl-3-methylimidazolium hexafluorophosphate (OMImPF₆).

The present disclosure will be further described with reference to Examples 1-9.

### Example 1

1-octyl-3-methylimidazolium hexafluorophosphate (OMImPF₆) was selected as an ionic liquid (IL) and poured into a quartz tube. Ferrocene was selected as a catalyst and added into the quartz tube. The resulting mixture in the quartz tube was magnetically stirred at ambient temperature for 30 minutes to obtain an ionic liquid phase, wherein a concentration of the catalyst in the ionic liquid phase is 25 mmol/L. A wastewater containing sulfamethoxazole (SMX) and a H₂O₂ solution with a concentration of 3% (i.e. a solution of 3 g hydrogen peroxide in 100 g water) were poured into a volumetric flask, deionized water was added to make a volume constant, and a pH of the resulting solution was adjusted to 3 to form an aqueous phase, wherein a concentration of sulfamethoxazole in the aqueous phase is 0.05 mmol/L, and a concentration of H₂O₂ in the aqueous phase is 10 mmol/L. 50 mL of the aqueous phase and 5 mL of the ionic liquid phase were mixed and stirred at ambient temperature for 30 minutes. The resulting mixture was then stood for 10 minutes to collect an upper aqueous phase, and the upper aqueous phase was subjected to a chromatographic analysis. The results show that a degradation efficiency of sulfamethoxazole in the aqueous phase is 97.2%.

### Example 2

1-octyl-3-methylimidazolium hexafluorophosphate (OMImPF₆) was selected as an ionic liquid (IL) and poured into a quartz tube. Ferrocene was selected as a catalyst and added into the quartz tube. The resulting mixture in the quartz tube was magnetically stirred at ambient temperature for 30 minutes to obtain an ionic liquid phase, wherein the ionic liquid phase has a concentration of the catalyst of 50 mmol/L. A wastewater containing sulfamethoxazole (SMX) and a H₂O₂ solution with a concentration of 3% were poured into a volumetric flask, deionized water was added to make a volume constant, and a pH of the resulting solution was adjusted to 5 to form an aqueous phase, wherein the aqueous phase has a concentration of sulfamethoxazole of 0.2 mmol/L, and a concentration of H₂O₂ of 30 mmol/L. 50 mL of the aqueous phase and 5 mL of the ionic liquid phase were mixed and stirred at ambient temperature for 5 hours. The resulting mixture was then stood for 10 minutes to collect an upper aqueous phase, and the upper aqueous phase was subjected to a chromatographic analysis. The results show that a degradation efficiency of sulfamethoxazole in the aqueous phase is 84.6%.

### Example 3

1-octyl-3-methylimidazolium hexafluorophosphate (OMImPF₆) was selected as an ionic liquid (IL) and poured into a quartz tube. Ferrocene was selected as a catalyst and added into the quartz tube. The resulting mixture in the quartz tube was magnetically stirred at ambient temperature for 30 minutes to obtain an ionic liquid phase, wherein the ionic liquid phase has a concentration of the catalyst of 35 mmol/L. A wastewater containing sulfamethoxazole (SMX) and a H₂O₂ solution with a concentration of 3% were poured into a volumetric flask, deionized water was added to make a volume constant, and a pH of the resulting solution was adjusted to 4 to form an aqueous phase, wherein the aqueous phase has a concentration of sulfamethoxazole of 0.125 mmol/L, and a concentration of H₂O₂ of 20 mmol/L. 50 mL of the aqueous phase and 5 mL of the ionic liquid phase were mixed and stirred at ambient temperature for 5 hours. The resulting mixture was then stood for 10 minutes to collect an upper aqueous phase, and the upper aqueous phase was subjected to a chromatographic analysis. The results show that a degradation efficiency of sulfamethoxazole in the aqueous phase is 91.6%.

### Example 4

1-octyl-3-methylimidazolium hexafluorophosphate (OMImPF₆) was selected as an ionic liquid (IL) and poured into a quartz tube. Ferrocene was selected as a catalyst and added into the quartz tube. The resulting mixture in the quartz tube was magnetically stirred at ambient temperature for 30 minutes to obtain an ionic liquid phase, wherein the ionic liquid phase has a concentration of the catalyst of 25 mmol/L. A wastewater containing sulfamethazine (SMZ) and a H₂O₂ solution with a concentration of 3% were poured into a volumetric flask, deionized water was added to make a volume constant, and a pH of the resulting solution was adjusted to 3 to form an aqueous phase, wherein the aqueous phase has a concentration of sulfamethazine of 0.05 mmol/L, and a concentration of H₂O₂ of 10 mmol/L. 50 mL of the aqueous phase and 5 mL of the ionic liquid phase were mixed and stirred at ambient temperature for 5 hours. The resulting mixture was then stood for 10 minutes to collect an upper aqueous phase, and the upper aqueous phase was subjected to a chromatographic analysis. The results show that a degradation efficiency of sulfamethazine in the aqueous phase is 96.4%.

### Example 5

1-octyl-3-methylimidazolium hexafluorophosphate (OMImPF₆) was selected as an ionic liquid (IL) and poured into a quartz tube. Iron dodecyl sulfonate was selected as a catalyst and added into the quartz tube. The resulting mixture in the quartz tube was magnetically stirred at ambient temperature for 30 minutes to obtain an ionic liquid phase, wherein a concentration of the catalyst in the ionic liquid phase is 30 mmol/L. Iron dodecyl sulfonate was prepared by the following steps: a solution of sodium dodecyl sulfonate and a solution of ferric chloride were heated to a temperature of 70° C. and then mixed to obtain a mixed solution. The mixed solution was naturally cooled to ambient temperature to generate a precipitate. The precipitate was filtered by a water-based filter membrane, washed 3 times by water, and dried by a freeze dryer to obtain iron dodecyl sulfonate. A wastewater containing sulfamethazine (SMZ) and a H₂O₂ solution with a concentration of 3% were poured into a volumetric flask, deionized water was added thereto to make a volume constant, and a pH of the resulting solution was adjusted to 3 to form an aqueous phase, wherein a concentration of sulfamethazine in the aqueous phase is 0.1 mmol/L, and a concentration of H₂O₂ in the aqueous phase is 20 mmol/L. 50 mL of the aqueous phase and 5 mL of the ionic liquid phase were mixed and stirred at ambient temperature for 1 hour. The resulting mixture was then stood for 10 minutes, to collect an upper aqueous phase, and the upper aqueous phase was then subjected to a chromatographic analysis. The results show that a degradation efficiency of sulfamethazine in the aqueous phase is 92.3%.

### Example 6

1-octyl-3-methylimidazolium hexafluorophosphate (OMImPF₆) was selected as an ionic liquid (IL) and poured into a quartz tube. Iron dodecyl sulfonate was selected as a catalyst and added into the quartz tube. The resulting mixture in the quartz tube was magnetically stirred at ambient temperature for 30 minutes to obtain an ionic liquid phase, wherein the ionic liquid phase has a concentration of the catalyst of 50 mmol/L. Iron dodecyl sulfonate was prepared by the following steps: a solution of sodium dodecyl sulfonate and a solution of ferric chloride were heated to a temperature of 70° C. and then mixed to obtain a mixed solution. The mixed solution was naturally cooled to ambient temperature to generate a precipitate. The precipitate was filtered by a water-based filter membrane, washed 3 times by water, and dried by a freeze dryer to obtain iron dodecyl sulfonate. A wastewater containing sulfamethazine (SMZ) and a H₂O₂ solution with a concentration of 3% were poured into a volumetric flask, deionized water was added thereto to make a volume constant, and a pH of the resulting solution was adjusted to 3.5 to form an aqueous phase, wherein the aqueous phase has a concentration of sulfamethazine of 0.2 mmol/L, and a concentration of H₂O₂ of 30 mmol/L. 50 mL of the aqueous phase and 5 mL of the ionic liquid phase were mixed and stirred at ambient temperature for 2.5 hours. The resulting mixture was then stood for 10 minutes, to collect an upper aqueous phase, and the upper aqueous phase was then subjected to a chromatographic analysis. The results show that a degradation efficiency of sulfamethazine in the aqueous phase is 93.4%.

### Example 7

1-octyl-3-methylimidazolium hexafluorophosphate (OMImPF₆) was selected as an ionic liquid (IL) and poured into a quartz tube. Copper dodecyl sulfonate was selected as a catalyst and added into the quartz tube. The resulting mixture in the quartz tube was magnetically stirred at ambient temperature for 30 minutes to obtain an ionic liquid phase, wherein the ionic liquid phase has a concentration of the catalyst of 40 mmol/L. Copper dodecyl sulfonate was prepared by the following steps: a solution of sodium dodecyl sulfonate and a solution of copper chloride were heated to a temperature of 70° C. and then mixed to obtain a mixed solution. The mixed solution was naturally cooled to ambient temperature to generate a precipitate. The precipitate was filtered by a water-based filter membrane, washed 3 times by water, and dried by a freeze dryer to obtain copper dodecyl sulfonate. A wastewater containing sulfamethazine (SMZ) and a H₂O₂ solution with a concentration of 3% were poured into a volumetric flask, deionized water was added thereto to make a volume constant, and a pH of the resulting solution was adjusted to 3 to form an aqueous phase, wherein the aqueous phase has a concentration of sulfamethazine of 0.05 mmol/L, and a concentration of H₂O₂ of 15 mmol/L. 50 mL of the aqueous phase and 5 mL of the ionic liquid phase were mixed and stirred at ambient temperature for 3 hours. The resulting mixture was then stood for 10 minutes, to collect an upper aqueous phase, and the upper aqueous phase was then subjected to a chromatographic analysis. The results show that a degradation efficiency of sulfamethazine in the aqueous phase is 94.1%.

### Example 8

1-octyl-3-methylimidazolium hexafluorophosphate (OMImPF₆) was selected as an ionic liquid (IL) and poured into a quartz tube. Ferrocene was selected as a catalyst and added into the quartz tube. The resulting mixture in the quartz tube was magnetically stirred at ambient temperature for 45 minutes to obtain an ionic liquid phase, wherein the ionic liquid phase has a concentration of the catalyst of 37.5 mmol/L. A wastewater containing sulfamethazine (SMZ) and a H₂O₂ solution with a concentration of 3% were poured into a volumetric flask, deionized water was added thereto to make a volume constant, and a pH of the resulting solution was adjusted to 3 to form an aqueous phase, wherein the aqueous phase has a concentration of sulfamethazine of 0.125 mmol/L, and a concentration of H₂O₂ of 20 mmol/L. 40 mL of the aqueous phase and 5 mL of the ionic liquid phase were mixed and stirred at ambient temperature for 2.75 hours.

### Example 9

1-octyl-3-methylimidazolium hexafluorophosphate (OMImPF₆) was selected as a ionic liquid (IL) and poured into a quartz tube. Ferrous dodecyl sulfonate was selected as a catalyst and added into the quartz tube. The resulting mixture in the quartz tube was magnetically stirred at ambient temperature for 60 minutes to obtain an ionic liquid phase, wherein the ionic liquid phase has a concentration of the catalyst of 40 mmol/L. Ferrous dodecyl sulfonate was prepared by the following steps: a solution of sodium dodecyl sulfonate and a solution of ferrous chloride were heated to a temperature of 70° C. and then mixed to obtain a mixed solution. The mixed solution was naturally cooled to ambient temperature to generate a precipitate. The precipitate was filtered by a water-based filter membrane, washed 3 times by water, and dried by a freeze dryer to obtain ferrous dodecyl sulfonate. A wastewater containing sulfamethazine (SMZ) and a H₂O₂ solution with a concentration of 3% were poured into a volumetric flask, deionized water was added thereto to make a volume constant, and a pH of the resulting solution was adjusted to 4 to form an aqueous phase, wherein the aqueous phase has a concentration of sulfamethazine of 0.15 mmol/L, and a concentration of H₂O₂ of 25 mmol/L. 55 mL of the aqueous phase and 5 mL of the ionic liquid phase were mixed and stirred at ambient temperature for 2 hours.

What is claimed is:

1. A method for degrading antibiotics by aqueous phase transfer catalysis using an anionic liquid and hydrogen peroxide, comprising:
step 1, adding hydrogen peroxide to a wastewater containing the antibiotics to obtain a first mixture, and adjusting a pH of the first mixture to 3-4 to form an aqueous phase; and
adding a catalyst to a water-insoluble ionic liquid to obtain a second mixture, and stirring the second mixture to form an ionic liquid phase, wherein the catalyst is selected from the group consisting of ferrocene, iron dodecyl sulfonate, ferrous dodecyl sulfonate and copper dodecyl sulfonate; and
step 2, mixing the aqueous phase and the ionic liquid phase obtained in step 1 in a volume ratio of (8-11):1 to obtain a mixed phase, and stirring the mixed phase to degrade the antibiotics.

2. The method of claim 1, wherein a concentration of the antibiotics in the aqueous phase is in a range of 0.05-0.2 mmol/L, a concentration of hydrogen peroxide in the aqueous phase is in a range of 10-30 mmol/L, and a concentration of the catalyst in the ionic liquid phase is in a range of 25-50 mmol/L.

3. The method of claim 1, wherein, in step 1, the stirring is performed at ambient temperature for 30-60 min.

4. The method of claim 1, wherein, in step 2, the stirring is performed for 0.5-5 hours.

5. The method of claim 1, wherein the ionic liquid is an ionic compound composed of anions and cations, and
the ionic liquid is insoluble in water and compatible with catalysts.
